(19) United States
(12) Patent Application Publication
(10) Pub. No.: US 2022/0156866 A1
(43) Pub. Date: May 19, 2022

(54) SYSTEMS, METHODS, AND USER INTERFACES FOR A WEB-BASED PERSONALIZED UPSKILLING PLATFORM INCLUDING PROVIDING UPSKILLING CONTENT TO USERS BASED ON ROLE DATA AND SKILL DATA

(71) Applicant: PricewaterhouseCoopers LLP, New York, NY (US)

(72) Inventors: Suneet DUA, St. Petersburg, FL (US); Darren Terrence LEE, St. Petersburg, FL (US); Sanjay VERMA, Atherton, CA (US); Samant KUMAR, San Jose, CA (US)

(73) Assignee: PricewaterhouseCoopers LLP, New York, NY (US)

(21) Appl. No.: 17/525,651

(22) Filed: Nov. 12, 2021

Related U.S. Application Data
(60) Provisional application No. 63/113,950, filed on Nov. 15, 2020.
(60) Provisional application No. 63/166,770, filed on Mar. 26, 2021.

(51) Int. Cl. G06Q 50/20; G06Q 10/06

(52) U.S. Cl. CPC G06Q 50/2057; G06F 3/0481; G06Q 10/063112

(57) ABSTRACT

Systems, methods, and graphical user interfaces for managing upskilling content are provided. An upskilling system ingests information regarding learners and regarding roles, including information regarding current skills (and skill levels) for individual learners and target skills (and skill levels) for roles. Skill gaps for learners are then identified based on the difference between current skills and target skills for a learner's role. The system selects upskilling content based on skill information associated with various pieces of upskilling content, wherein the selected content is selected such that the learner may reduce or eliminate a skill gap by consuming the selected content. The system associates upskilling content with role profiles for roles and/or with user profiles for learners. The system provides access to upskilling content, via a graphical user interface, for learners, and monitors consumption of upskilling content by learners.

### RELATED APPLICATIONS

This application claims benefit to U.S. Provisional Application No. 63/113,950, filed Nov. 15, 2020, and to U.S. Provisional Application No. 63/166,770, filed Mar. 26, 2021, the entire contents of each of which are incorporated herein by reference.

### BACKGROUND

Distributed users of electronic systems may be provided access to upskilling content such as training videos, courses, quizzes, and interactive learning materials. Consumption of said upskilling content may be allow the user consuming the content—e.g., a learner—to gain new skills, and/or to increase their skill levels for existing skills Known systems and methods for organizing upskilling content, selecting upskilling content for consumption by users, and providing upskilling content to users rely on manual organization and selection of upskilling content (whether by system administrators or by content consumers). Known systems and methods for tracking user skills rely on manual tracking of changes to user skills over time (whether by system administrators or by content consumers) and manual determinations of how content consumption relates to changes in skills.

### SUMMARY

As explained above, known systems and methods for managing and providing upskilling content to distributed users rely on manual methods for organization and selection of upskilling content, and for tracking user skills for users consuming upskilling content. Said known methods for providing upskilling content and tracking user skills are inefficient, scale poorly, and are prone to human error and inconsistency. Accordingly, there is a need for improved systems and methods for managing and providing upskilling content to distributed users and for updating user profiles to reflect changes in skills and increases in skill levels attributable to users consuming upskilling content. In particular, there is a need for systems and methods for providing said functionalities in an automated, accurate, efficient, and scalable manner Described herein are systems and methods that may address one or more of said needs.

Disclosed herein are systems, methods, and graphical user interfaces for providing an upskilling platform. As described and demonstrated herein, an upskilling platform may be usable by enterprises or by other large organizations to generate and visualize insights regarding their own organization and/or other organizations, to provide and manage consumption of upskilling content (e.g., media, articles, courses, etc.) to employees or other members of the organization, and to provide an ecosystem for the exchange of digital assets (e.g., automations, bots, or other digital solutions) that may be provided by employees.

In some embodiments, a system providing the platform may be configured to automatically (e.g., periodically or in response to a trigger condition being satisfied) ingest data representing a plurality of organizations (e.g., companies, non-profit organizations, enterprises, etc.). The data may be ingested from a plurality of data sources including but not limited to, e.g., job listing data describing job openings and required/desired skills and experience for applicants for the particular role, job description data describing a current employee's role within an organization and/or the employee's skills and experience, and/or social media information in which an employee describes their role within an organization and/or skills and experience. In some embodiments, the system may also ingest data that is provided manually by a user (such as an administrator at an organization); for example, an organization may provide an organizational chart, employee roster, job information data, and/or employee information data.

The ingested data may be cleaned and formatted for storage in one or more databases of the system. In some embodiments, the data may be wholly or partially anonymized (or an anonymized version of the data may be created). In some embodiments, one or more automated algorithms (e.g., machine learning algorithms) may be applied to the ingested data in order to generate data to characterizing an organization, a role within the organization, and/or one or more skills associated with a role within an organization.

In some embodiments, a system providing the platform may be configured to automatically (e.g., periodically or in response to a trigger condition being satisfied) ingest data representing upskilling content. In some embodiments, the system may be configured to automatically ingest or otherwise receive upskilling content, which may include media content (e.g., videos), trainings, courses, articles, interactive modules, or the like. In some embodiments, upskilling content may be received from any one or more of a plurality of sources, including from third-party educational and/or training content providers. The content may be ingested from a plurality of data sources including but not limited to, e.g., third-party commercial educational content sources, university content sources, other educational institution content sources, publicly available sources or video content and/or interactive training content, and/or internal sources of video content and/or interactive training content. In some embodiments, the system may also ingest data that is provided manually by a user (such as an administrator at an organization); for example, an administrator may automatically upload internally-generated videos and/or other upskilling content.

The upskilling content itself may be ingested along with metadata that indicates skill information about one or more skills associated with the upskilling content. In some embodiments, the received upskilling content may include metadata that associates the received content with one or more roles (e.g., job types or jobs) and/or with one or more skills. For example, the upskilling content may indicate that it is intended to train employees to increase their skill levels in a particular skill. In some embodiments, the received upskilling content may not include information regarding which roles and/or skills it pertains to, and a user of the system may manually indicate which roles and/or skills certain upskilling content pertains to, or the system may be configured to automatically determine (e.g., using one or more automated algorithms) which roles and/or skills certain upskilling content pertains to. The system may be configured to automatically (with or without user input) and/or algorithmically, determine skill information for ingested upskilling content. Skill information may include information indicating prerequisite (required or recommended) skills for a piece of upskilling content, and/or information indicating one or more skills that may be increased upon consumption/completion of a piece of content (including an indication of an amount by which one or more skill levels may be increased).

Once data regarding one or more organizations, one or more roles, one or more users, and one or more pieces of upskilling content has been ingested, the system may then provide one or more user interfaces for using that data to visualize insights about organizations, employees or other members within those organizations, roles and role types (e.g., job titles) within those organizations, and/or skills or specific employees or associated with specific job types within one or more of those organizations. In some embodiments, the system may also provide functionality for generating role profiles representing user roles and associated target skills, for generating user profiles representing specific users and their current (and/or target) skills, and for linking upskilling content (e.g., media content objects) with one or more role profiles and/or with one or more user profiles.

In some embodiments, the system may be configured to generate, store, and/or visualize information regarding one or more role profiles, which may be used, as described herein, in selecting upskilling content to provide to users. Role profiles may be generated based, e.g., on the ingested job description and job posting data, and the information about each role that is displayed when a user selects to view the role may be determined based on the ingested data. For example, when a user instructs the system to display information about a role, the system may display a list of skills associated with that role. In some embodiments, the system may display an indication of a relative importance of a particular skill to the selected role. In some embodiments, when a user instructs the system to display information about a role, the system may display one or more indications of upskilling content that is associated with the role, for example by displaying representations of courses, credentials, articles, videos, or other upskilling content associated with the role and/or with skills associated with the role. In some embodiments, a user of the graphical user interface may be able to manually edit role profile information such as by editing the skills (or their importance) and/or the upskilling content associated with a role.

In some embodiments, a role profile may store information representing an association of the role with upskilling content. For example, the information may indicate that the upskilling content is indicated for recommended (or required) completion by employees in that role. The information may indicate a quantification of a strength of the association (e.g., a match level or match percentage) of the upskilling content and the role. In some embodiments, the system may store information, for example in a role profile, indicating how engagement with upskilling content (e.g., completion of a course, watching a video series, etc.) may increase a user's skill levels; for example, the information may indicate which skills will be increased and/or an extent to which skills will be increased. In some embodiments, the system may be configured to automatically generate this linking data that defines how upskilling content relates to one or more role profiles, for example based on metadata about the upskilling content and/or based on information about the roles. In some embodiments, a user may be able to manually modify the upskilling content (including the skill increases attainable by engaging upskilling content) in a role profile.

In some embodiments, the system may be configured to generate, store, and/or visualize user profile information for a specific employee, which may include information regarding the employee's role(s), skill levels, current engagement/progress with one or more pieces of upskilling content, and/or upskilling content to be recommended to and/or provided to the employee for consumption. In some embodiments, the system may automatically determine (e.g., by applying one or more algorithms) what upskilling content should be associated with a user profile, for example based on consulting one or more associated role profiles. In some embodiments, the system may automatically select upskilling content for a particular worker that will increase the worker's skill levels in order to address skill gaps in which the worker's current skill levels do not meet the target skill levels defined by a role profile for the worker's role. In some embodiments, upskilling content for a particular worker may be prioritized based on which skill gaps for the user are associated with the most important skills for that user's role, or based on which skill gaps are the largest and/or will take the longest to remedy through upskilling content. In some embodiments, the user profile interface may display a strength of a match score for a particular piece of upskilling content to the user.

Automatically determination of skills and/or skill levels that are associated with a certain role, and automatically determine of skills and/or skill levels that are possessed by a certain user, may be based on, for example, use of one or more natural language understanding and/or machine learning algorithms that analyze the content of ingested data associated with a role and/or with a user, to determine one or more skills and/or skill levels for that role or user based thereon.

As described below, based on a comparison of a user's current skills and skill levels to the target skills and skill levels for a user's role, the system may automatically (e.g., algorithmically) determine (and/or visualize) one or more skill gaps for a user (or for an organization as a whole). Based on identified skill gaps, the system may select one or more pieces of upskilling content to be linked to a user, such that the piece of upskilling content will be suggested for, required for, and/or automatically transmitted to the user. The selected upskilling content may be selected on the basis that skill information associated with the upskilling content indicates that consumption of the content may increase a skill level for which the user has a skill gap.

Visualizing role and skill data for various organizations (and/or for specific roles or users therein) may allow for users of the graphical user interface to glean insights about role gaps and skill gaps at their own organizations (e.g., by comparing to peer organization, market leaders, or industry/sector averages) and/or for specific roles or users therein, which may allow organizations to make intelligent and effective choices regarding upskilling of existing employees. In some embodiments, a user of the platform may be able to use visualized insights to drive decisions regarding which upskilling content to deliver to employees via the platform.

In some embodiments, in addition to the graphical user interface provided for use by an enterprise manager or administrator (e.g., an upskilling content administrator), the system may also provide a graphical user interface for use by individual employees or other members of an organization. In some embodiments, the platform may be configured such that each employee in an organization may be able to access a personal account on the platform in order to view and update information about their own profile and/or browse/consume upskilling content.

In some embodiments, the system may be configured to automatically select and present, via the graphical user interface rendered on the employee's own user device, one or more pieces of upskilling content. The upskilling content may be automatically selected by the system based on the employee's role, the employee's current skill levels, and target skill levels indicated by a role profile for the employee's role. The system may automatically select content that will enable the employee to close skill gaps by consuming the content. In some embodiments, the graphical user interface rendered on the employee's device may present a number of upskilling content options from which the employee is able to choose.

In some embodiments, the graphical user interface rendered on the employee's device may include a visual indication of skill levels that will be improved (and/or an extent to which those skill levels will be improved) by consuming certain upskilling content. In some embodiments, the employee may be able to choose from among a plurality of upskilling content options that are presented as options via the graphical user interface.

In some embodiments, after the employee selects and consumes/completes a piece of upskilling content, the system may update the employee's profile to indicate completion of the upskilling content and to adjust any skill levels in accordance with completion of the upskilling content. In some embodiments, the upskilling content may need to be completed in a satisfactory manner (e.g., achieving success on an examination or obtaining approval from a reviewer) in order for the skill level increase to be obtained. Additionally, after the employee selects and consumes/completes a piece of upskilling content, the system may update the upskilling content that is recommended or required for the employee. For example, by increasing skill levels and/or completing specific upskilling content, the employee may “unlock” or progress to new upskilling content that was previously unavailable (or not suggested) to them. In some embodiments, progressing to new upskilling content may occur in accordance with updates to an employee's current skill levels; in some embodiments, progressing may occur in accordance with the employee progressing through a predefined track of sequentially organized upskilling content (e.g., a series of content organized into a cohesive “course”).

In some embodiment, the user interface may provide functionality for employees to rate content that they have consumed. The system may user employee rating feedback in order to drive future decisions regarding how and to whom the content should be distributed. The system may also use a specific employee's feedback to drive determinations as to what content should be presented to that specific employee in the future.

In some embodiments, the user interface may provide functionality for employees to create and join employee groups with one another. Employee groups may be suggested or formed based on employee roles, skills, and/or skill levels. Groups may allow employees to communicate with one another via the platform, including by sharing upskilling content and/or commentary on upskilling content.

In some embodiments, a first system, for associating media content with roles, is provided, the first system comprising one or more processors configured to cause the first system to: receive a first data set comprising a plurality of role descriptions, wherein one or more of the plurality of role descriptions comprises an indication of one or more skills; receive a second data set comprising an indication of a plurality of media content objects; generate, based on the first data set, the role profile for the role, wherein the role profile comprises data indicating a plurality of skills associated with the role; and generate, based on the second data set, data associating the role profile with one or more media content objects of the plurality of media content objects.

In some embodiments of the first system, receiving the first data set comprises receiving data from one or more sources selected from: a job posting data source; a job description data source, a data source associated with a single entity of the plurality of entities; a data source associated with more than one of the plurality of entities; and a social media data source.

In some embodiments of the first system, receiving the first data set comprises one or more methods of receipt selected from: performing automated scraping of one or more data sources, receiving a batch upload; receiving the first data set according to a predetermined schedule; receiving the first data set in response to a predefined trigger condition; and receiving an update to previously-received data.

In some embodiments of the first system, receiving the second data set comprises receiving data from one or more sources selected from: a courses data source configured to provide a plurality of course media content objects; a credentials data source configured to provide a plurality of credential media content objects, and a news/articles content data source configured to provide a plurality of news/article media content objects.

In some embodiments of the first system, receiving the second data set comprises one or more methods of receipt selected from: performing automated scraping of one or more data sources, receiving a batch upload; receiving the second data set according to a predetermined schedule; receiving the second data set in response to a predefined trigger condition; and receiving an update to previously-received data.

In some embodiments of the first system, generating the role profile comprises applying one or more automated algorithms.

In some embodiments of the first system, generating the data associating the role profile with the one or more media content objects comprises applying one or more automated algorithms.

In some embodiments of the first system, generating the data associating the role profile with the one or more media content objects is based on the plurality of skills associated with the role.

In some embodiments of the first system, the system is configured to select, from the second data set, a subset of media content objects to be associated with the role profile, wherein the selection is based on the role profile and the second data set indicating that the role and the subset of media content objects are commonly associated with one or more skills.

In some embodiments of the first system, the one or more processors are further configured to cause the system to: receive a user input comprising an instruction to modify the data associating the role profile with the one or more media content objects; and in response to receiving the user input, modify the data associating the role profile with the one or more media content objects in accordance with the user input.

In some embodiments of the first system, the instruction to modify the data associating the role profile with the one or more media content objects comprises an instruction to perform one or more of the following: associating a new media content object with the role profile, disassociating one or more of the media content objects from the role profile, modifying an indicated importance of one or more of the media content objects to the role, and modifying a display order for one or more of the media content objects for the rile profile.

In some embodiments of the first system, the data associating the role profile with one or more media content objects comprises an indication of one or more worker skill levels to be modified in response to detecting that a respective media content object has been consumed by the worker.

In some embodiments of the first system, the one or more processors are further configured to cause the system to determine the one or more worker skill levels based on the second data set indicating that the respective media content object is associated with one or more skills associated with the one or more worker skill levels.

In some embodiments, a first method, for associating media content with roles, is provided, the first method performed at a system comprising one or more processors, the first method comprising: receiving a first data set comprising a plurality of role descriptions, wherein one or more of the plurality of role descriptions comprises an indication of one or more skills; receiving a second data set comprising an indication of a plurality of media content objects; generating, based on the first data set, the role profile for the role, wherein the role profile comprises data indicating a plurality of skills associated with the role; and generating, based on the second data set, data associating the role profile with one or more media content objects of the plurality of media content objects.

In some embodiments, a first non-transitory computer-readable storage medium, storing instructions for associating media content with roles, is provided, wherein the instructions are executable by a system comprising one or more processors to cause the system to: receive a first data set comprising a plurality of role descriptions, wherein one or more of the plurality of role descriptions comprises an indication of one or more skills; receive a second data set comprising an indication of a plurality of media content objects; generate, based on the first data set, the role profile for the role, wherein the role profile comprises data indicating a plurality of skills associated with the role; and generate, based on the second data set, data associating the role profile with one or more media content objects of the plurality of media content objects.

In some embodiments, a second system, for visualizing workforce data, is provided, the second system comprising one or more processors configured to cause the second system to: receive a first data set comprising an indication of an organizational structure and respective descriptions of a plurality of entities within the organizational structure; cause display of a graphical user interface comprising a visualization region; receive, via the graphical user interface, a first user input comprising an indication of a member within the organizational structure; and in response to receiving the first input, cause display in the display region of a visualization of information regarding the member.

In some embodiments of the second system, wherein the indication of an organizational structure comprises an organizational chart.

In some embodiments of the second system, the first user input comprising an indication of a member comprises one or more inputs selected from the following: typing of the name of the member, selection of a user-interface affordance associated with the member, selection of the member from a list of the plurality of members within the organizational structure, selection of a visualization of the member within a visualization of the organizational chart.

In some embodiments of the second system, the visualization of information regarding the member comprises a visualization of one or more of the following: a member role for the member, a member skill level for a skill of the member, and a member engagement level characterizing engagement by the member with one or more media content object.

In some embodiments of the second system: the one or more processors are further configured to cause the system to: receive a second data set comprising an indication of a plurality of media content objects; and associate the member with a set of one or more of the plurality of media content objects; and the visualization indicates an association of the member with all or part of the set of media content objects.

In some embodiments of the second system, receiving the second data set comprises receiving data from one or more sources selected from: a courses data source configured to provide a plurality of course media content objects; a credentials data source configured to provide a plurality of credential media content objects, and a news/articles content data source configured to provide a plurality of news/article media content objects.

In some embodiments of the second system, receiving the second data set comprises one or more methods of receipt selected from: performing automated scraping of one or more data sources, receiving a batch upload; receiving the second data set according to a predetermined schedule; receiving the second data set in response to a predefined trigger condition; and receiving an update to previously-received data.

In some embodiments of the second system, associating the member with the set of media content objects comprises applying one or more automated algorithms.

In some embodiments of the second system, associating the member with the set of media content objects is based on a determination by the system, based on the information regarding the member and based on the second data set, that the member and the one or more of the plurality of media content objects are commonly associated with a same role.

In some embodiments of the second system, associating the member with the set media content objects is based on a determination by the system, based on the information regarding the member and based on the second data set, that the member and the one or more of the plurality of media content objects are commonly associated with a same skill.

In some embodiments of the second system, one or more processors are further configured to automatically select subset of the set of media content objects for inclusion in the visualization, wherein selection of the subset is based on comparing a current skill level of the member to a target skill level for members of a same role type as the member.

In some embodiments of the second system, the visualization indicating an association of the member with all or part of the set of media content objects further indicates a progress level of the member in engaging one or more of the set of media content objects.

In some embodiments, a second method, for visualizing workforce data, is provided, the second method performed at a system comprising one or more processors, the second method comprising: receiving a first data set comprising an indication of an organizational structure and respective descriptions of a plurality of members within the organizational structure; causing display a graphical user interface comprising a visualization region; receive, via the graphical user interface, a first user input comprising an indication of a member within the organizational structure; and in response to receiving the first input, causing display in the display region of a visualization of information regarding the member.

In some embodiments, a second non-transitory computer-readable storage medium, storing instructions for visualizing workforce data, is provided, wherein the instructions are executable by a system comprising one or more processors to cause the system to: receive a first data set comprising an indication of an organizational structure and respective descriptions of a plurality of members within the organizational structure; display a graphical user interface comprising a visualization region; receive, via the graphical user interface, a first user input comprising an indication of a member within the organizational structure; and in response to receiving the first input, cause display in the display region of a visualization of information regarding the member.

In some embodiments, a third system, for providing media content, is provided, the third system comprising one or more processors configured to cause the third system to: receive user data comprising an indication of a first plurality of skills for a user; generate and store a user profile for the user based on the user data, wherein the user profile indicates a plurality of skill levels for the user; receive media content data comprising a plurality of media content objects and metadata indicating associations of the respective media content objects with a second plurality of skills; receive, from a user device associated with the user, a first media content object request; and in response to receiving the first media content object request: select one or more of the plurality of media content objects, wherein the selected one or more media content objects are indicated by the metadata as being associated with a skill associated with a skill level indicated in the user profile; and transmit, to a user device associated with the user, an indication of the selected one or more media content objects.

In some embodiments of the third system, the user profile indicates a skill level for a first skill of the first plurality of skills.

In some embodiments of the third system, receiving the media content data comprises receiving data from one or more sources selected from: a courses data source configured to provide a plurality of course media content objects; a credentials data source configured to provide a plurality of credential media content objects, and a news/articles content data source configured to provide a plurality of news/article media content objects.

In some embodiments of the third system: the user device associated with the user comprises one or more selected from: a personal computer, a mobile device, and a workstation computer; the system is configured to cause the user device to display a graphical user interface configured to display media content to the user; and the first media content object request comprises the user navigating to a media content portion of the graphical user interface.

In some embodiments of the third system, selecting the one or more media content objects is based on a comparison of the skill level indicated in the user profile against a target skill level for members of a role type indicated by the user profile.

In some embodiments of the third system, the one or more processors are further configured to: receive an indication from the user device that the user has consumed the media content object; and in accordance with the indication received from the user device, update the user profile for the user to indicate an increase in the skill level, wherein the skill level that is increased is indicated by the metadata as being associated with the media content object.

In some embodiments of the third system, the system determines an amount by which to increase the skill level in accordance with a performance level by the user in consuming the media content object.

In some embodiments of the third system, the system is further configured to, in accordance with the indication received from the user device, provide an updated selection of media content objects for future consumption by the user.

In some embodiments of the third system, the selected one or more media content objects comprise one or more selected from the group of: a video, a slide show, an article, and an interactive assessment.

In some embodiments, a third method, for providing media content, is provided, the third method performed at a system comprising one or more processors, the third method comprising: receiving user data comprising an indication of a first plurality of skills for a user; generating and store a user profile for the user based on the user data, wherein the user profile indicates a plurality of skill levels for the user; receiving media content data comprising a plurality of media content objects and metadata indicating associations of the respective media content objects with a second plurality of skills; receiving, from a user device associated with the user, a first media content object request; and in response to receiving the first media content object request: selecting one or more of the plurality of media content objects, wherein the selected one or more media content objects are indicated by the metadata as being associated with a skill associated with a skill level indicated in the user profile; and transmitting, to a user device associated with the user, an indication of the selected one or more media content objects.

In some embodiments, a third non-transitory computer-readable storage medium, storing instructions for providing media content, is provided, wherein the instructions are executable by a system comprising one or more processors to cause the system to: receive user data comprising an indication of a first plurality of skills for a user; generate and store a user profile for the user based on the user data, wherein the user profile indicates a plurality of skill levels for the user; receive media content data comprising a plurality of media content objects and metadata indicating associations of the respective media content objects with a second plurality of skills; receive, from a user device associated with the user, a first media content object request; and in response to receiving the first media content object request: select one or more of the plurality of media content objects, wherein the selected one or more media content objects are indicated by the metadata as being associated with a skill associated with a skill level indicated in the user profile; and transmit, to a user device associated with the user, an indication of the selected one or more media content objects.

In some embodiments, any of the above systems, methods, and computer-readable storage media may be combined, in whole or in part, with one another, and/or with any other features disclosed herein.

### BRIEF DESCRIPTION OF THE DRAWINGS

FIG. 1 shows a system providing a personalized web-based upskilling and digital asset management platform, according to some embodiments.

FIG. 2 shows a method for linking a role profile to media content objects, according to some embodiments.

FIG. 3 shows a graphical user interface screen for displaying information regarding role profile and linked media content objects, according to some embodiments.

FIG. 4 shows a method for visualizing an member within an organization, including optionally visualizing one or more media content objects linked to the member, according to some embodiments.

FIG. 5 shows a graphical user interface screen for visualizing an member within an organization, including optionally visualizing one or more media content objects linked to the member, according to some embodiments.

FIG. 6 shows a method for providing media content objects to a user and updating a user profile to reflect upskilling for the user in accordance with the user consuming the media content object, according to some embodiments.

FIGS. 7A-7F show graphical user interface screens for browsing and consuming upskilling content, according to some embodiments.

FIG. 8 shows a computer, in accordance with some embodiments.

### DETAILED DESCRIPTION

Reference will now be made in detail to various embodiments, examples of which are illustrated in the accompanying drawings. Wherever possible, the same reference numbers will be used throughout the drawings to refer to the same or like parts. Moreover, use of the indefinite article “a” or “an” in the specification and the claims is meant to include one or more of the feature that it introduces, unless otherwise indicated.

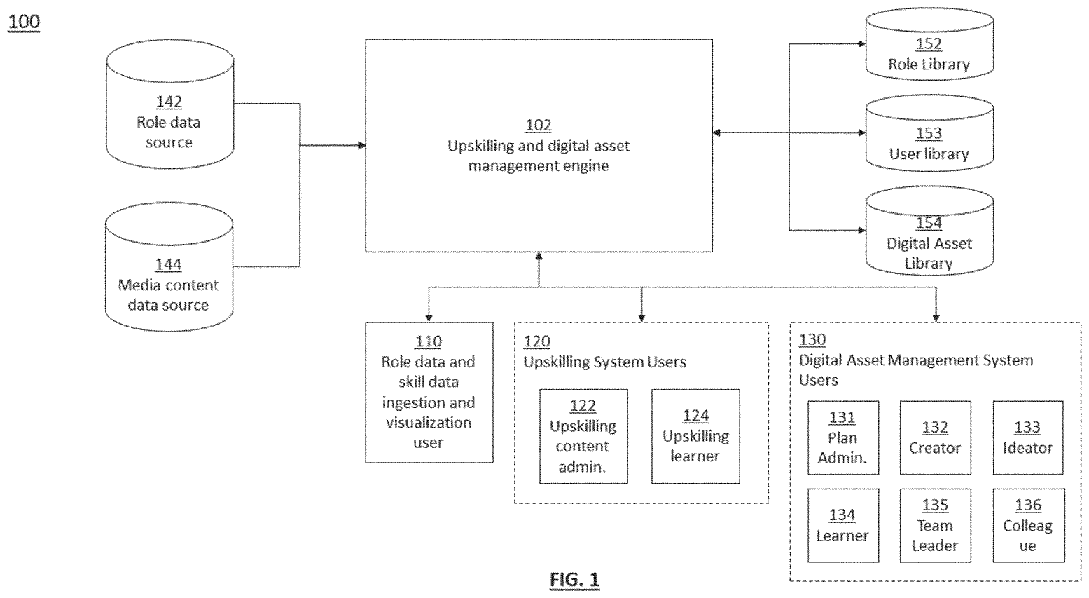

FIG. 1 shows a system 100 providing a personalized web-based upskilling and digital asset management platform, according to some embodiments. As shown, system 100 comprises a central upskilling and digital asset management engine 102 configured to communicate (e.g., via wired or wireless electronic communication) with a plurality of user devices, data sources, and libraries. Upskilling and digital asset management engine 102 may comprise one or more processors. Users of system 100 may include a role data and skill data ingestion and visualization user 110, upskilling system users 120, and digital asset management system users 130. Data sources include role data source 143 and media content data source 144. Libraries include role library 152, user library 153, and digital asset library 154.

As described herein, various users of system 100 may be associated with different roles, different permissions, and/or different associated graphical user interface screens. Furthermore, users may be associated with user-specific profiles (e.g., stored information associate with the user) that indicates the user's role, the user's permissions, and/or the user's skills and skill levels. The users depicted in FIG. 1 are exemplary, and in some embodiments system 100 may include additional users of other user types/roles. In some embodiments, a single user may interact with system 100 in more than one of the user roles/types contemplated by FIG. 1. As shown in FIG. 1, users of system 100 may include:
Role data and skill data ingestion and visualization user 110, who may interact with one or more user interface screens configured to allow the user to control ingestion of role data and skill data and to generate one or more visualizations representing roles within an organization, skills of members of an organization, skills of certain role types, skills of specific users/employees, comparisons of different organizations, and/or comparisons of different users;
Upskilling content administrator 122, who may interact with one or more user interface screens configured to allow the user to manage creation and/or modification of user profiles for upskilling learners (e.g., profiles for employees who will consume upskilling media content), creation and/or modification of role profiles, ingestion of upskilling media content, and/or creation of data associating upskilling media content with one or more role profiles and/or one or more user profiles;
Upskilling learner 124, who may interact with one or more user interface screens configured to allow the user to consume upskilling content (e.g., upskilling media content) in order to obtain additional skills and/or to increase skill levels for existing skills;
Plan administrator 131, who may interact with one or more user interface screens configured to allow the user to review digital asset submissions, determine one or more users to whom digital assets and/or upskilling content are submitted, and/or determine a manner in which one or more digital assets and/or upskilling content are distributed amongst users;
Creator 132, who may interact with one or more user interface screens configured to allow the user to create and upload a digital asset submission, optionally including digital asset code and associated metadata;
Ideator 133, who may interact with one or more user interface screens configured to allow the user to create and upload a digital asset solicitation (e.g., an “idea”);
Learner 134, who may interact with one or more user interface screens configured to allow the user to consume upskilling content (e.g., upskilling media content) and/or digital assets in order to obtain additional skills and/or to increase skill levels for existing skills;
Team leader 135, who may interact with one or more user interface screens configured to allow the user to review digital asset submissions, determine one or more users to whom digital assets and/or upskilling content are submitted, and/or determine a manner in which one or more digital assets and/or upskilling content are distributed amongst users; and
Consumer 136, who may interact with one or more user interface screens configured to allow the user to view, review, implement, test, rate, “like,” and/or submit feedback for one or more digital assets.

Upskilling and digital asset management engine 102 may communicate with the plurality of users by transferring data to and/or receiving data from a plurality of user devices belonging to said plurality of users. In some embodiments, user devices may include desktop computers, laptops, smart phones, and/or tablets. In some embodiments, upskilling and digital asset management engine 102 may cause one or more graphical user interface (GUI) screens to display on the display of a user device. Depending on the user, the one or more GUI screens may be configured to display information and/or receive user input related to role data ingestion and visualization, skill data ingestion and visualization, upskilling, and/or digital asset management.

In some embodiments, upskilling and digital asset management engine 102 may receive data representing a plurality of organizations. Organizations may include companies, non-profit organizations, enterprises, educational institutions, and the like. Upskilling and digital asset management engine 102 may ingest data representing roles (e.g., employee positions) within an organization from role data source 142. In some embodiments, role data source 142 may include one or more data sources for job listings and/or job descriptions, such as company websites, social media and/or professional networking websites (e.g., LinkedIn) and/or such as job listing websites. Role data received from role data source 142 may include job listing data describing job openings and required/desired skills and experience for applicants for the particular role, job description data describing a current employee's role within an organization and/or the employee's skills and experience, social media information in which an employee describes their role within an organization and/or skills and experience, organizational charts for one or more organizations, employee rosters for one or more organizations, job information data relating to one or more organizations, and/or employee information data relating to one or more organizations.

In some embodiments, upskilling and digital asset management engine 102 may be configured to generate one or more role profiles based on role data received from role data source 142. A role profile may comprise data describing the required and/or desired skills and experience necessary to fulfill a corresponding role within an organization. In some embodiments, role profiles may be specifically configured for one organization (or a set of organizations); in some embodiments, role profiles may be configured generally for all organizations using system 100. Role profiles may be stored by system 100 in role library 152, which may include and/or provide any suitable electronic storage systems (e.g., databases).

In some embodiments, in addition to role profiles stored in role library 152, system 100 may include user profiles stored in user library 153. While role profiles may indicate information regarding average (and/or optimal) skills and skill levels for a certain role type, a user profile may include user information—including role information, skill type information, and skill level information—for a specific user. Information stored regarding a specific user may include user identification information, the user's organization, the user's position within the organization's structure, one or more roles of the user within the organization, and an indication of what skills (and associated skill levels) the user possesses. In some embodiments, user profiles, role information for a user, and skill information for a user may be automatically ingested and/or extracted from one or more data sets provided to system 100, and/or may be explicitly indicated by one or more users of system 100 creating and/or configuring user profiles. Thus, upskilling and digital asset management engine 102 may have access to information regarding the current skills and skill levels of employees within an organization, as well as the target skills and skill levels for users having that role. One or more system operations may be carried out in accordance with skill gaps (e.g., skill deltas) representing a difference between a user's current skill levels and target skill levels for that user's role or roles.

Upskilling and digital asset management engine 102 may be configured to increase or decrease a skill level of a skill for an employee upon receipt of certain data (e.g., data indicating that an employee has consumed upskilling content, or indicating that a user has created, implemented, and/or consumed a digital asset). In some embodiments, users (e.g., organization administrators) of system 100 may manually review, approve, and/or modify skill levels and/or skill level adjustments for users.

Upskilling and digital asset management engine 102 may ingest data representing media content from media content data source 144. In some embodiments, media content may include upskilling content and may comprise articles, videos, essays, podcasts, quizzes, and/or interactive courses. In some embodiments, media content data source 144 may include one or more external sources of educational courses (e.g., a university website, a commercial educational content source, etc.), websites for hosting videos (e.g., YouTube), academic journals, magazines, newspapers, and/or social media sites (e.g., LinkedIn). In some embodiments, upskilling and digital asset management engine 102 may be configured to link role profiles with ingested media content related to the role. For example, engine 102 may generate metadata associating specific courses or other media content with a certain role profile, such that the indicated media content may serve as upskilling content for users of the indicated role. When users consume the indicated media content, engine 102 may then automatically cause the user's skill levels to increase by an amount indicated by metadata associated with the media content and/or with the role profile for the user's role. In some embodiments, upskilling and digital asset management engine 102 may transmit ingested media content data to digital asset library 154 for storage, optionally in association with metadata relating to upskilling via the indicated media content.

In some embodiments, system 100 may be configured to execute methods for ingesting, storing, processing, managing, and providing upskilling content to users, including by providing upskilling content to users in accordance with user skill information and role skill information, and including updating user skill information in accordance with a user's completion/consumption of upskilling content. As described herein, said methods may be performed, in whole or in part, by a web-based upskilling system such as system 100.

Upskilling and digital asset management engine 102 may receive upskilling content from media content data source 144 (and/or from any other suitable source of media content and/or other upskilling content). The received upskilling content, which may include videos, courses, training content, articles, and the like, may be received in association with metadata that describes the content, its source, one or more persons or organizations associated with the content, one or more roles associated with the content, and/or one or more skills (or associated skill levels) associated with the content. After receiving the upskilling content and/or associated metadata, the content and/or associated metadata may be saved by the system on any suitable computer storage medium, such as in a database accessible to the system. In some embodiments, the system may store pointers to the upskilling content rather than storing the upskilling content itself.

In some embodiments, the system may generate and store data that associates the received upskilling content with associated role data and/or associated skill data. Individual pieces of upskilling content may be respectively linked to (e.g., stored in association with) respective role data and/or respective skill data. In some embodiments, role data for a piece of upskilling content may indicate one or more roles with which the upskilling content is or should be associated. In some embodiments, skill data may indicate one or more skills (optionally including skill levels for said skills) with which the upskilling content is or should be associated. The received metadata may, in some embodiments, itself include data that links the upskilling content to one or more roles and/or to one or more skills, for example by explicitly indicating one or more roles and/or one or more skills associated with the upskilling content. In some embodiments, the system may process the received upskilling content and/or metadata linked to the received content to algorithmically determine what roles and/or skills should be associated with the upskilling content, for example by applying one or more natural language understanding and/or one or more machine learning algorithms.

In addition to receiving upskilling content, engine 102 may receive role data and user data, which may be used, as described above, to generate one or more role profiles and/or one or more user profiles. A role profile may describe attributes of a corresponding role, including by describing skill data (including skills, skill levels, and/or skill importance) for a role. In some embodiments, a role profile may indicate the same role information for a plurality of organization or entities; in some embodiments, a role profile may indicate different skill information for the same role at different entities (or different role profiles for the same role at different entities may be generated and stored). A user profile, meanwhile, may describe attributes of a corresponding user (e.g., a specific person), including by describing skill data (including skills, skill levels, and/or skill importance) for a user. A user may be associated with a role (as indicated in their user profile) and differences between the skill data indicated in the user profile and skill data indicated by a corresponding role profile for the user's role may thus define a skill gap defined by one or more target skills and/or target skill levels, where the user's skills (as indicated in the user profile) do not meet target levels for the user's role (as indicated by the role profile).

As described herein, the system may determine a skill gap for a user, and may use the determined skill gap to select one or more pieces of upskilling content to be associated with the user. After determining a skill gap (for example by comparing skill data in a user's user profile to skill data in a corresponding role profile associated with the user's role, the system may select one or more pieces of upskilling content that correspond to the skill gap. The system may select upskilling content that is associated with skill data indicating that the upskilling content will add new skills that the user needs to add (as indicated by the user's skill gap(s)) and/or that the upskilling content will skill levels that the user needs to increase (as indicated by the user's skill gap(s)). The selected pieces of upskilling content may then be associated with the user.

Associating upskilling content with the user may cause the upskilling content to be linked to the user, such that data is stored reflecting an association between the user and the content. The system may then transmit the upskilling content (or an indication thereof) to the user, and/or the system may cause the upskilling content (or an indication thereof) to be displayed to the user, such that the user may be prompted via a graphical user interface to consume/complete the upskilling content.

In some embodiments, one or more system users (e.g., upskilling content administrator 122) may have the ability to manually review and/or adjust the manner in which upskilling content is linked to role profiles and/or to specific user profiles. Thus, while the system may automatically (e.g., algorithmically) determine said linkages, certain users may be able to interact with the system, for example through a graphical user interface visualizing a role profile and/or a visualizing a user profile, to approve and/or edit what content is linked to certain roles and/or to certain users. The user reviewing and/or editing linkages between upskilling content and role-/user-profiles may access the system through a content administrator GUI, which may be displayed on a device (e.g., a mobile electronic device or a personal computer) of the administrator (e.g., administrator 122).

In some embodiments, one or more system users (e.g., upskilling learner 234) may have the ability to browse and consume upskilling content that has been curated by the system based on the user's skill gaps. For example, the user may browse upskilling content by accessing a graphical user interface rendered on the user's device, wherein the GUI displays options for upskilling content that is suggested for, required for, and/or available to the user. In some embodiments, the GUI may display information about the content of the upskilling content as well as the upskilling opportunities (e.g., what skills it will add, what skill levels it will increase) associated with the content.

After a user consumes/completes a piece of upskilling content, the user's skills may be adjusted accordingly, and one or more updates to information displayed on GUIs of the system may be made. For example, a visualization of the learner's skill information, as shown for example in the user's profile, may be updated on a GUI displayed to the learner and/or to a system administrator. Furthermore, upskilling content that is provided to the learner by being suggested or otherwise displayed on a GUI of the learner may be adjusted, such that the GUI may show new recommended upskilling content. New upskilling content selected for the user following completion by the user of previous upskilling content may be automatically selected by the system based on an updated analysis of the user's (remaining) skill gaps, based on upskilling content that is newly available to the system (e.g., newly ingested), and/or based on the learner's progression through a predefined series of interrelated pieces of content (such as where multiple pieces of content are linked together into a sequential course through which the user much progress in a predefined manner, completing one piece of content before moving on to the next).

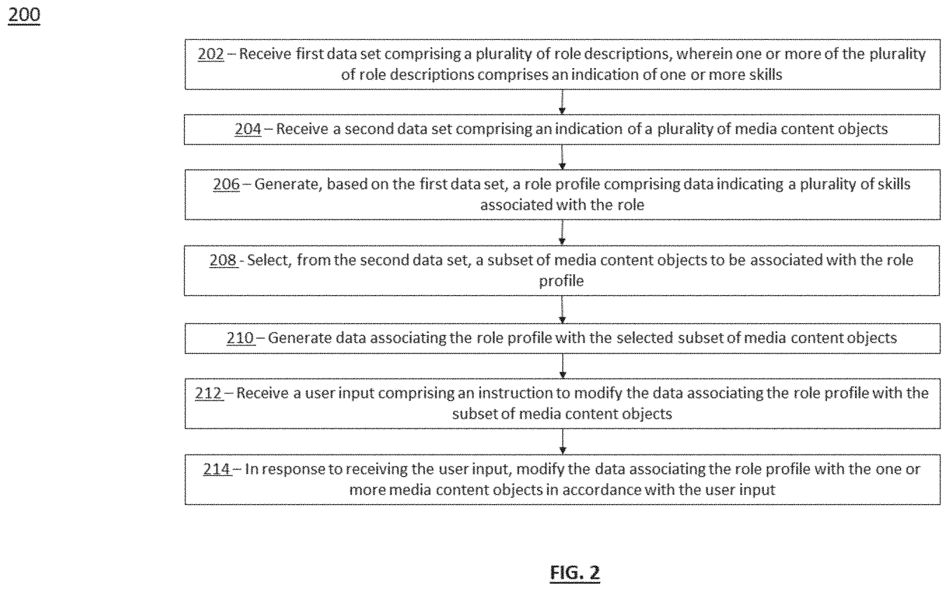

FIG. 2 shows a method 200 for linking a role profile to media content objects, according to some embodiments. Method 200 may be performed by one or more processors of an upskilling system, such as by engine 102 of system 100 described above with reference to FIG. 1.

At block 202, in some embodiments, the system receives a first data set comprising a plurality of role descriptions, wherein one or more of the role descriptions comprises an indication of one or more skills. Receiving the data set may comprise one or more methods of receipt, including: performing automated scraping of one or more data sources; receiving a batch upload; receiving the data set according to a predetermined schedule; receiving the data set in response to a predefined trigger condition; and/or receiving an update to previously received data. The data set may comprise information ingested by the system from a job description data source, a job posting data source, a data source associated with one or more organizations (e.g., a company website), a social media data source (e.g., LinkedIn), and/or a user.

The role description data may include information indicating that certain roles (e.g., job titles, positions) are or are not present within certain organizations/entities. The role description data may indicate the identities of persons who hold one or more roles, and the entity within which those persons hold said roles. The role description data may indicate skills (including skill levels and/or skill importance) associated with certain roles, for example in the form of required or preferred skills associated with a job listing for a role, or associated with a job description of a role on a company website. The role description data may indicate skills (including skill levels and/or skill importance) associated with a specific person holding a role at a given entity, for example in the form of a description of a person's skills or experiences (e.g., on a bio page for an employee on a company website, on a person's resume of CV, or on a person's social media page).

Received role description data may be stored by the system on any suitable electronic storage medium, such as by being stored on and/or in association with a database of role library 152.

At block 204, in some embodiments, the system receives a second data set comprising an indication of a plurality of media content objects. Receiving the data set may comprise one or more methods of receipt, including: performing automated scraping of one or more data sources; receiving a batch upload; receiving the data set according to a predetermined schedule; receiving the data set in response to a predefined trigger condition; and/or receiving an update to previously received data.

The second data set may include media content objects themselves, and may include metadata describing the content, source, associated persons or organizations, past usage, and/or recommended usage for any one or more of the media content objects. Media content objects may include any upskilling content such as videos, courses, tests, articles, interactive training materials, or the like. The data set may comprise information ingested by the system from one or more sources of professional training materials, educational materials, a video source, a source for test materials, or the like.

The second data set may include information indicating that certain media content objects (e.g., certain videos, courses, trainings, etc.) are or are not present associated with one or more skills (including skill levels and/or skill importance). For example, the second data set may indicate that a certain training video will increase a certain skill level (e.g., by a certain amount) for users who watch the video. The media content may thus be associated with skill information that may indicate skills the content will provide to learners, and amount by which the content will increase a skill level for a learner, a prerequisite skill (and/or skill level) for a learner, a recommended skill (and/or skill level) for a learner, and/or one or more conditions (e.g., completion/consumption conditions for determining user has successfully completed/consumed the content) for determining that a skill should be added or increased for a learner.

Received media content data (including media content objects, other upskilling content, and/or associated metadata including associated skill data) may be stored by the system on any suitable electronic storage medium, such as by being stored on and/or in association with a database of system 100.

At block 206, in some embodiments, in the system generates, based on the first data set, a role profile, wherein the role profile comprises data indicating a plurality of skills associated with the role. For example, the system may extract skill and/or skill level information from the received data, and may generate and store a data structure representing a role profile, wherein the stored role profile data represents skill and skill level information for the represented role. In some embodiments, the role profile may comprise data indicating the level of importance of each of the one or more skills to the role. (In some embodiments, a skill level and an importance level for a skill may be separate concepts (though they may be related, e.g., derived from overlapping data), such that a role profile may store both skill level information for a skill and skill importance information for a skill. In some embodiments, the system may generate a role profile for a role automatically (e.g., algorithmically). Additionally or alternatively, the system may generate a role profile based on one or more user inputs, for example based on a user input received from an upskilling administrator, such as administrator 122. In some embodiments, the system may store the role profile in any suitable computer storage medium, such as in (or in association with) a database of role library 152 described above with reference to FIG. 1.

In some embodiments, a role profile may in some embodiments correspond specifically to one entity/organization (or specifically to one set of entities/organizations); in some embodiments, a role profiles may correspond generally to all entity using system 100. In some embodiments, a role profile may include information about a role that is applicable to all entities using the system. In these instances, for example, the same information about the role may be displayed and/or used with respect to any entity. In some embodiments, a role profile may include information about a role that is specifically applicable only to one entity or only to one set of entities. In these instances, for example, different information about a single role may be displayed and/or used by the system with respect to different entities. In some embodiments, separate role profile data structures for the same role may be stored for different entities. In some embodiments, a single role profile data structure may include different information that corresponds respectively to different respective entities, for example by including different skill information (skills for a role, skill prevalence for the role, target skill levels for the role, importance level for the skill for the role) for different entities.

At block 208, in some embodiments, the system selects, from the second data set, a subset of media content objects to be associated with the role profile. The system may automatically (e.g., algorithmically) select a subset of ingested media content objects to be linked to the role profile, such that the linked content is recommended and/or required for consumption by users having the role associated with the role profile. In some embodiments, linking of media content to the role profile may include linking media content to the role profile along with an indication that only a certain subset of users in that role (e.g., users at a certain entity, or users with one or more certain skills) should themselves be linked to the media content.

The linking of media content to a role profile may, in some embodiments, be made on the basis of a determination that there is overlap or correspondence between skill information for a role profile and skill information for a piece of media content. If the role profile indicates that users in that role should have certain skills (and/or certain skill levels for certain skills), and data regarding a piece of media content indicates that the media content will allow a user to obtain said same skills and/or skill levels, then the system may determine that the media content should be linked to the role profile. In some embodiments, linking of media content to a role profile may cause the linked media content to be suggested for consumption (and/or transmitted to) users in the role. In some embodiments, linking of media content to a role profile may cause the linked media content to be suggested for consumption (and/or transmitted to) users in the role only if the user's user profile further indicates a skill gap that the system determines can be mitigated by consumption of the media content.

In some embodiments, selection of the subset of media content may be performed in a wholly automated (e.g., wholly algorithmic) manner; in some embodiments, one or more user inputs may be receive by the system and used as a basis for selecting the subset of media content objects.

At block 210, in some embodiments, the system generates data associating the role profile with the selected subset of media content objects. In some embodiments, data associating the role profile with the selected subset of media content objects may be stored on any suitable computer storage medium, including by being stored as a part of (or in association with) the role profile itself. A role profile may thus be iteratively updated to store data in the role profile linking the role profile to various media content as the content is ingested, processed, and analyzed.

At block 212, in some embodiments, the system receives a user input comprising an instruction to modify the data associating the role profile with the subset of media content objects. The user input may be received via a user interface, for example a user interface visualizing one or more linkages between media content and role profiles. For example, the user interface may be a graphical user interface displaying a visualization of a role profile and showing what media content objects are associated with the role profile. The interface may be displayed on the device of a user such as upskilling content administrator 122.

In some embodiments, the input received by the system may include an instruction to link media content to a role profile, to unlink media content from a role profile, and/or to adjust a manner in which media content is linked to a role profile (for example by adjusting the skill information for the role profile with which the content is associated, and/or by adjusting the skill adjustments that is afforded to users associated with the role profile who complete/consume the media content). In some embodiments, for example, a user of a graphical user interface for editing a role profile may be able to drag-and-drop representations of media content into and out of a visualization of a role profile, thereby causing the system to link or unlink the represented media content from the represented role profile. In some embodiments, for example, a user of a graphical user interface for editing a role profile may be able to adjust one or more sliders to adjust skill levels (e.g., prerequisite skill levels and/or skill levels by which or to which a skill will be increased) associated with a media content object for a role profile. Other GUI affordances may be used to adjust the manner in which media content is linked to a role profile, including by selecting one or more users or sets of users to whom the content should be linked, or for whom an adjustment to the linkage should be applied.

At block 216, in some embodiments, in response to receiving the user input, the system modifies the data associating the role profile with the one or more media content objects in accordance with the user input. Data associating the role profile with one or more media content objects, as stored for example as part of a data structure representing the role profile, may be adjusted (e.g., modified, augmented, wholly or partially overwritten). A role profile may thus be updated to reflect changes to the role profile instructed by a user of a graphical user interface of the system, including by adjusting the stored association of the role profile with one or more pieces of media content usable for upskilling of users.

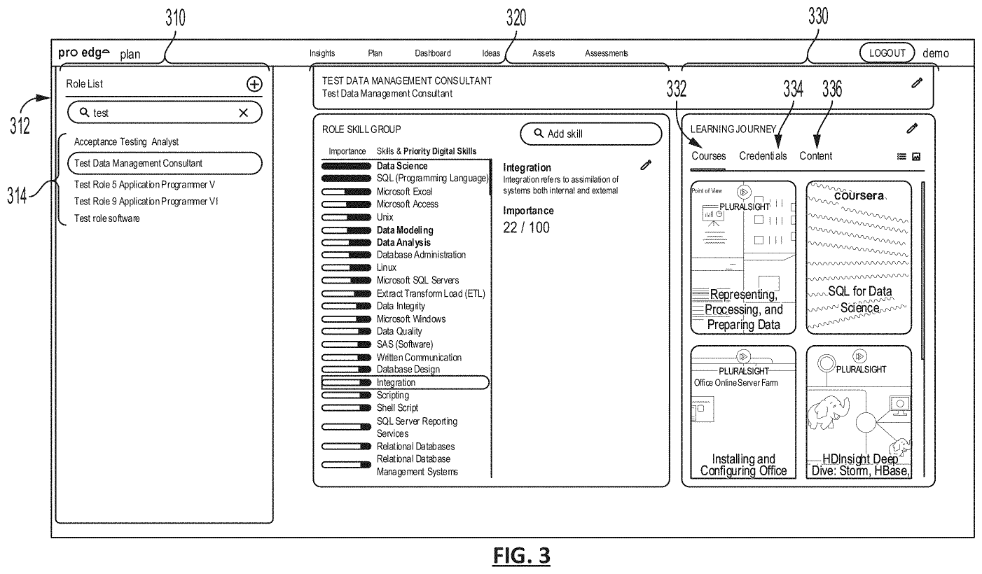

FIG. 3 shows a graphical user interface screen for displaying information regarding role profile and linked media content objects, according to some embodiments. A GUI including the GUI screen shown in FIG. 3 may be caused to be displayed on a user device by one or more processors included in a system for upskilling and digital asset management, for example by system 100 described above with reference to FIG. 1. The GUI may be displayed to one or more users (e.g., user 122) viewing or editing information about role profiles and the manner in which media content objects are associated with role profiles. In some embodiments, the GUI may be the GUI that accepts the user input described above at block 212 of method 200.

As shown, the GUI screen may include a role library portion 310, which may include a displayed list of roles 314 and a search field 312 that may accept user inputs that allow a user to search/filter the displayed list 314. The list 314 may display names of roles for which a role profile is stored by the system, for example by displaying a list of all (or some) of the role profiles that are stored in role library 152 of system 100. The GUI may be configured such that a user can select a role profile from the displayed list 314, such as by clicking or tapping on one or the displayed role titles. In some embodiments, clicking or tapping on a role title in list 314 may constitute a user input configured to cause the GUI to display a visualization of role data (including, e.g., associated skill data) for the corresponding role profile.

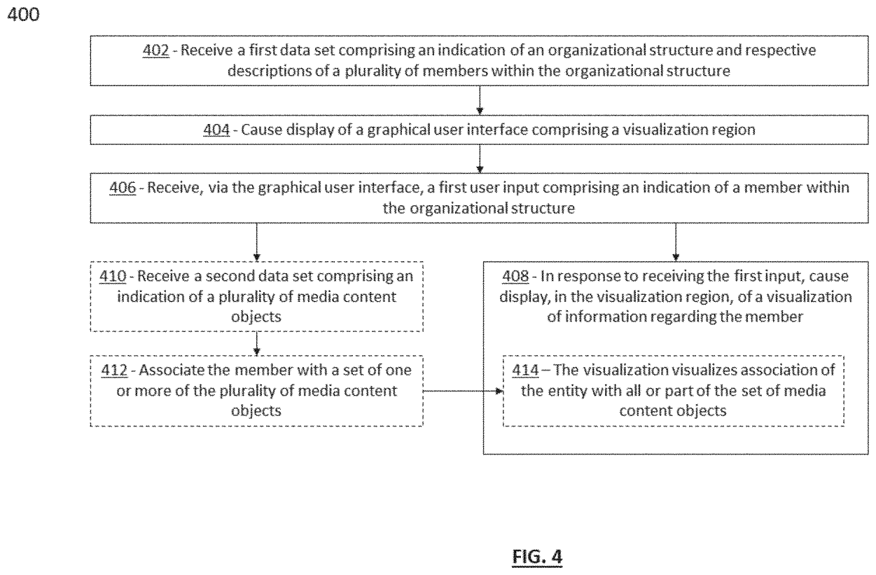

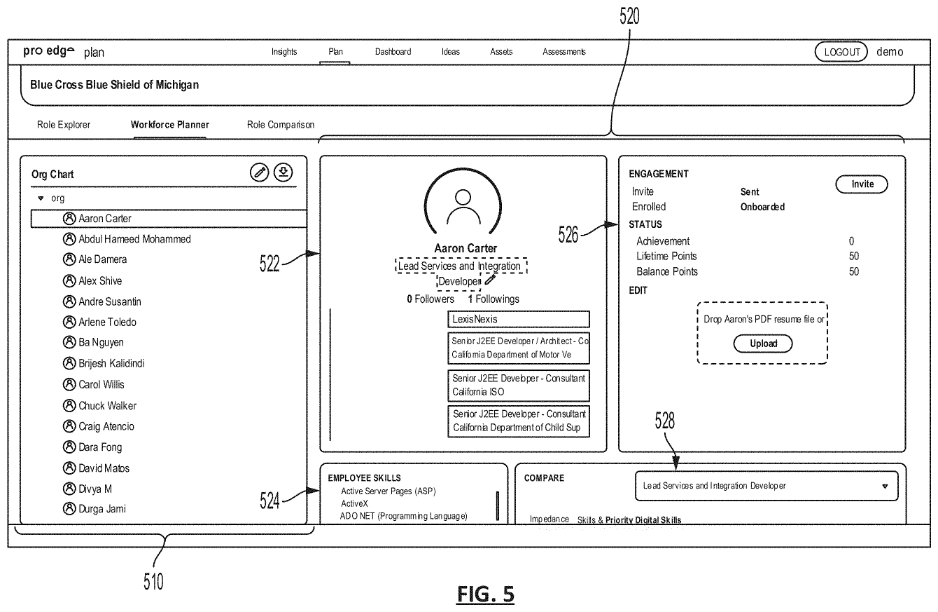

In some embodiments, when the user selects a role of interest (e.g., from list 314), the system may cause the GUI to display a role profile visualization 320 corresponding to the selected role. In the example shown in FIG. 5, the user has selected the “Test Data management Consultant” role from list 314, thereby causing role profile visualization 320 to be displayed. As shown, role profile visualization 320 comprises a skill list 322 associated with the depicted role profile. In some embodiments, the skills included in skill list 322 may be ordered by level of prevalence, importance, and/or skill level (e.g., target skill level for the skill). In the example shown, the displayed skills in list 322 are ranked by importance, and the importance level of each skill is visually indicated by the respective bars corresponding to each list item.

In some embodiments, displayed skill information may be interactive. For example, one or more user interface objects in role profile visualization 320 may be able to be selected by a user to cause display of additional corresponding information. In some embodiments, a user may click on or tap on a displayed skill in the role profile visualization, and the system may responsively cause additional information about the selected skill to be displayed. In the example shown, the user has clicked on the “integration” skill, which causes the system to cause display of skill importance quantification visualization 324, which shows a numerical quantification of the skill importance, and of a written definition of the skill. Importance level quantification visualization 324 may include a numerical score which indicates the skill's importance level relative to a maximum importance level.

In some embodiments, the GUI displaying the visualization of role profiles includes a learning journey panel 330. In some embodiments, learning journey panel 330 may be configured to display visual representations of upskilling content and/or media content objects (e.g., courses (tab 332), credentials (334), content (336), videos, training modules, articles, or other media content objects) and/or digital assets that are associated with the depicted role. Upskilling content, media content objects, and/or digital assets that are represented in panel 330 may be those that are linked to the role profile such that they are recommended (or required) for consumption by users in the represented role. Thus, when the system makes a determination, as described above, to link a piece of media content to a role profile, then a visual representation of the linked media content may be displayed in panel 330.

As shown in FIG. 3, the GUI screen may include various affordances (as represented by the pencil icons) allowing a user to edit content of one or more aspects of the depicted role profile. For example, a user with sufficient permissions (e.g., user 122) may use the GUI to edit skill information and/or learning journey information for the depicted role profile, for example by adding or removing skills or by adding or removing upskilling content or digital assets. For example, a user may click or tap the pencil icon in panel 330 in order to enter an editing mode that allows a user to use the GUI to edit the media content that is linked to the visualized role profile. In some embodiments, the user may be able to drag and drop visual representations of media content into or out of panel 330 in order to link and unlink the represented media content objects from the represented role. In accordance with the user executing these editing inputs, the system may update the role profile to save the user's changes to the stored role profile data.

FIG. 4 shows a method 400 for visualizing an member within an organization, including optionally visualizing one or more media content objects linked to the member, according to some embodiments. Method 400 may be performed by one or more processors of an upskilling system, such as by engine 102 of system 100 described above with reference to FIG. 1.

At block 402, in some embodiments, the system receives a first data set comprising an indication of an organizational structure and respective descriptions of a plurality of members within the organizational structure. In some embodiments, the input may be received in the form of an upload of an organization chart. In some embodiments, the input may be received in the form of a user entering a plurality of inputs to create an organization chart through a graphical user interface. In some embodiments, the input may be received in the form of upload of information pertaining to a single member of an organization, such as when information is imported for a new hire. In some embodiments, the input may be received via scraping information from data sources such as company websites, hiring websites, social media pages, financial records, corporate records, articles, videos, resumes, curricula vitae, or the like.

The received data set may in some embodiments include an explicit indication of information about the member (e.g., biographical information), information about the member's role within one or more organizations, information about the member's current skills (e.g., skill levels, skill importance), and/or information about the member's target skills. For example, explicit indication of any of the above information a be provided to the system when a user manually enters inputs into one or more fields soliciting the above information. Alternatively or additionally, the received data set may include an implicit indication of any of the above information about the member. For example, implicit indication of any of the above information a be provided to the system when the system scrapes or otherwise ingests information from data sources such as company websites, hiring websites, social media pages, financial records, corporate records, articles, videos, resumes, curricula vitae, or the like. In instances in which data containing one or more implicit indications of the above-recited information is ingested, the ingested data may be processed by one or more algorithms (e.g., natural language processing algorithms and/or machine learning algorithms) in order to extract the above-recited information.

The above-recited information may be stored by the system on any suitable computer storage medium, such as by being stored on a database of user library 153. In some embodiments, the information may be used to generate one or more user profiles, as explained above, which may be stored by the system. As explained above, a user profile may indicate information about a specific user of the system including biographic information, information regarding the member's role within one or more organizations, and information about the member's skills (including skill levels).

At block 404, in some embodiments, the system causes display of a graphical user interface comprising a visualization region. The graphical user interface may be configured to allow users to view user profiles stored in (or accessible to) the system. The graphical user interface may comprise a visualization region configured to display one or more visualizations (e.g., interactive visualizations) for visualizing information associated with one or more user profiles. The graphical user interface may comprise one or more affordances (e.g., icons, fields, menus, etc.) that can be used by a user of the graphical user interface to interact with data stored by (or accessible to) the system in order to cause the system to generate (and/or modify) and display one or more visualizations based on the user profile data (and/or based on the underlying ingested data).

The graphical user interface may be displayed on a user device of a user of system 100, such as upskilling content administrator 122 or learner 124. In some embodiments, learner 124 may be the member for whom information was ingested (and, optionally, for whom a user profile was generated or updated) at block 402. In some embodiments, the displayed graphical user interface may include, for example, one or more features shown and/or described below with reference to FIG. 5.

At block 406, in some embodiments, the system received, via the graphical user interface, a first user input comprising an indication of a member within the organizational structure. In some embodiments, a user of the graphical user interface may select a visual indication of a member, or may enter data (e.g., type a name or identification) identifying a member of the organization. In the example of FIG. 5, a user may click or tap on a name in the member list 510. In some embodiments, a user may click or tap on a visualization of a user shown graphically (e.g., as part of a tree diagram) as part of an organizational structure. Data regarding the user's input may be transmitted from the user's device (e.g., the device of user 122) to one or more processors (e.g., engine 102) of the system.

At block 408, in some embodiments, in response to receiving the first user input, the system causes display, in the visualization region, of a visualization of information regarding the member. The visualization of information regarding the member may include a visualization of any of the ingested data regarding the member, and/or any of the information determined about the member, based on said ingested data, by application of one or more processing algorithms. The visualization of information regarding the member may include visualization of skill data regarding the member (e.g., current skills, target skills, skill levels, skill importance levels, and/or skill gaps), visualization of biographical information regarding the member, visualization of role information regarding one or more roles of the member, visualization of information regarding one or more organizations of which the member is a part, visualization of media content (e.g., upskilling content) associated with the member, visualization of the member's progress through upskilling content, and/or visualization of a comparison of characteristics of the member to one or more other persons or roles.

In some embodiments, the displayed visualization may be a visualization of user profile data for the member, and may include any of the features shown in user profile visualization region 520 of FIG. 5.

At block 410, in some embodiments, the system receives a second data set comprising an indication of a plurality of media content objects. Receipt of data associated with media content objects, along with any associated metadata, and subsequent processing of said received data, may share any one or more characteristics in common with the receipt of data associated with media content objects described above with reference to block 204.

At block 412, in some embodiments, the system associates the member with a set of one or more of the plurality of media content objects. In a similar manner as described above with reference to the system associating a role profile with a set of media content objects, the system may at block 412 associate a user profile (or other representation of a specific member) with a set of media content objects. Similar to the process described above regarding selecting media content objects to be associated with a role profile, the system may analyze skill information associated with a user profile and skill information associated with media content objects in order to select media content objects to be associated with the role profile where there is a correspondence between the skill data. In particular, the system may analyze skill gap data for a user profile, wherein skill gap data represents a difference between a current skill level for a member (indicated in user profile skill data) versus a target skill level for persons in a that member's role (indicated in role profile skill data). The system may then select one or more media content objects whose associated skill data indicate that the content will help the member to close any existing skill gaps for the member, for example by adding target skills that the member does not possess and/or by increasing skill levels of the member to approach or reach a target skill level.

In some embodiments, associating the member with a set of one or more of the plurality of media content objects may be based entirely on an automated (e.g., algorithmic) analysis performed by the system by analyzing skill data. In some embodiments, additionally or alternatively, associating the member with a set of one or more of the plurality of media content objects may be based on one or more user inputs, for example a user input executed via a GUI (e.g., by user 122) instructing that one or more media content objects should be associated with or disassociated from a specific user profile.

In some embodiments, associating the member with a set of one or more of the plurality of media content objects may comprise storing data representing the association between the member and the set of one or more of the plurality of media content objects, for example by storing said data in association with and/or as a part of data representing the user profile for the member. For example, user profile stored in a database of user library 153 may be updated to include data associating the member with a set of one or more of the plurality of media content objects.

At block 414, in some embodiments, the visualization of block 408 visualizes association of the member with all or part of the set of media content objects. For example, the visualization may include a title, title card, and/or other visual representation representing one or more of the selected media content objects that are associated with the member. In some embodiments, the visualization may visualize skill information associated with a visualized media content object, for example visualizing how the member can achieve upskilling (e.g., what skills, and by what skill level amounts) by consuming/completing the content. In some embodiments, the visualization may include an indication of a basis on which the media content object was selected for association with the member (for example by indicating what skill gap(s) the content may help to close, or by indicting that the content was manually added for the user).

FIG. 5 shows a graphical user interface screen for visualizing a member within an organization, including optionally visualizing one or more media content objects linked to the member, according to some embodiments. A GUI including the GUI screen shown in FIG. 5 may be caused to be displayed on a user device by one or more processors included in a system for upskilling and digital asset management, for example by system 100 described above with reference to FIG. 1. The GUI may be displayed to one or more users (e.g., user 122) viewing or editing information about user profiles and the manner in which media content objects are associated with user profiles. In some embodiments, the GUI may be the GUI that accepts the user input described above at block 406 of method 400.

As shown, the GUI screen may include member list 510, which may present a list of members in one or more organizations. In some embodiments, list 510 may alternatively be presented as a graph visualization or a tree visualization. Users of the GUI screen may be able to select (e.g., click or tap) on member names in list 510 to select a member and to cause information about the selected member to be displayed in user profile visualization region 520. In some embodiments, clicking or tapping on a member name in list 510 may constitute a user input configured to cause the GUI to display a visualization of member data (including, e.g., associated skill data and/or a representation of one or more associated media content objects) for the corresponding member.

User profile visualization region 520 may include a visualization of biographical information regarding the member, a visualization of skill data regarding the member (e.g., current skills, target skills, skill levels, skill importance levels, and/or skill gaps) (e.g., as shown in employee skills panel 524), a visualization of role information regarding one or more roles of the member, a visualization of information regarding one or more organizations of which the member is a part, a visualization of media content (e.g., upskilling content) associated with the member, visualization of the member's progress through upskilling content, a visualization of engagement by the member with upskilling content and/or with the upskilling platform (e.g., as shown by engagement panel 526), and/or visualization of a comparison of characteristics of the member to one or more other persons or roles (e.g., as shown in comparison panel 528).

In some embodiments, displayed skill information, such as the information displayed in employee skills panel 524, may be interactive. For example, a user may click on or tap on a displayed skill in panel 524, and the system may responsively cause additional information about the selected skill to be displayed. In some embodiments, additional information displayed may include a skill level quantification visualization, which may shows a numerical quantification of a skill level for the skill for the user.

In some embodiments, a GUI displaying the visualization of a user profile may include a learning journey panel, which may share any one or more characteristics in common with learning journey panel 330 described above with reference to FIG. 3. A learning journey panel for a user profile may show representations of media content objects that are linked to a specific member's user profile (e.g., rather than showing representations of media content objects that are linked to a role profile in general). Thus, when the system makes a determination to link a piece of media content to a member's user profile, then a visual representation of the linked media content may be displayed in a learning journey panel for a user profile of the member.

As shown in FIG. 5, the GUI screen may include one or more affordances (e.g., as represented by the pencil icon) allowing a user to edit content of one or more aspects of the organizational structure and/or a depicted user profile for a member. For example, a user with sufficient permissions (e.g., user 122) may use the GUI to add, remove, or edit membership in the organization represented by list 510. Additionally or alternatively, a user with sufficient permissions (e.g., user 122) may use the GUI to edit user profile information for a member, such as by editing skill information and/or learning journey information for a visualized user profile. For example, a user of the GUI may add, remove, or adjust skills for a member; and/or may add, remove, or adjust upskilling content (e.g., media content objects) or digital assets that are associated with a member. In some embodiments, the user may be able to drag and drop visual representations of media content into or out of a portion of visualization region 520 in order to link and unlink media content objects from the represented user profile. In accordance with the user executing these editing inputs, the system may update the member's user profile to save the changes to the stored user profile data.

FIG. 6 shows a method for providing media content objects to a user and updating a user profile to reflect upskilling for the user in accordance with the user consuming the media content object, according to some embodiments. Method 600 may be performed by one or more processors of an upskilling system, such as by engine 102 of system 100 described above with reference to FIG. 1.

At block 602, in some embodiments, the system may receive user data comprising an indication of a first plurality of skills for a user. In some embodiments, the system may receive the data comprising skill data for the user in a same or similar manner as described above with respect to the system ingesting data from publicly available data sources (e.g., scraping company websites, social media, resumes, CV's, etc.) and/or in a same or similar manner as described above with respect to the system receiving uploaded data from a system administrator (receiving upload of employee information, organization charts, or the like). The data received may include any of the skill data described herein, including current skills for the user, target skills for the user, current skill levels for the user, target skill levels for the user, and/or skill importance information for the user.

At block 604, in some embodiments, the system may generate and store a user profile for the user based on the user data, wherein the user profile indicates a plurality of skill levels for the user. Generating the user profile may share any one or more characteristics in common with generating a user profile as described above with reference to user profiles stored on a database of user library 153 and/or with reference to block 402 of method 400. A user profile may indicate information about a specific user of the system including biographic information, information regarding the user's role within one or more organizations, and information about the user's skills (including current skills, target skills, current skill levels, target skill levels, and/or skill importance). User profile information may be stored, in some embodiments, on any suitable computer storage medium, for example on a database of user library 153.

At block 606, in some embodiments, the system may receive media content data comprising a plurality of media content objects and metadata indicating associations of the respective media content objects with a second plurality of skills. Receipt of media content data may share any one or more characteristics in common with receipt of media content data as described elsewhere herein, for example receipt of data as described with reference to block 204 of method 200 and/or receipt of data as described with reference to block 410 of method 400. The media content data that is received may include skill data, or skill data may be generated or extracted based on the media content data received, wherein the skill data may indicate one or more skills (including skill levels) associated with the respective media content objects. As described elsewhere herein, the skill data associated with the received media content may then be used by the system to select media content to be associated with (e.g., linked to) one or more role profiles and/or one or more user profiles. As described herein, linking media content to a user may be done on the basis of a determination by the system that skill data for the media content indicates that consumption/completion of the media content will add a skill or increase a skill level for which a user profile indicates a skill gap.

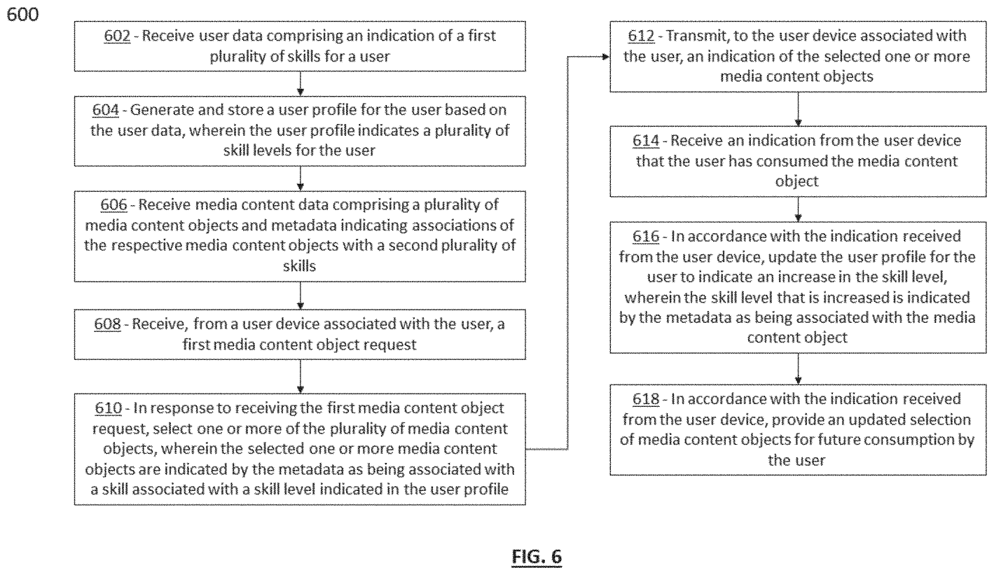

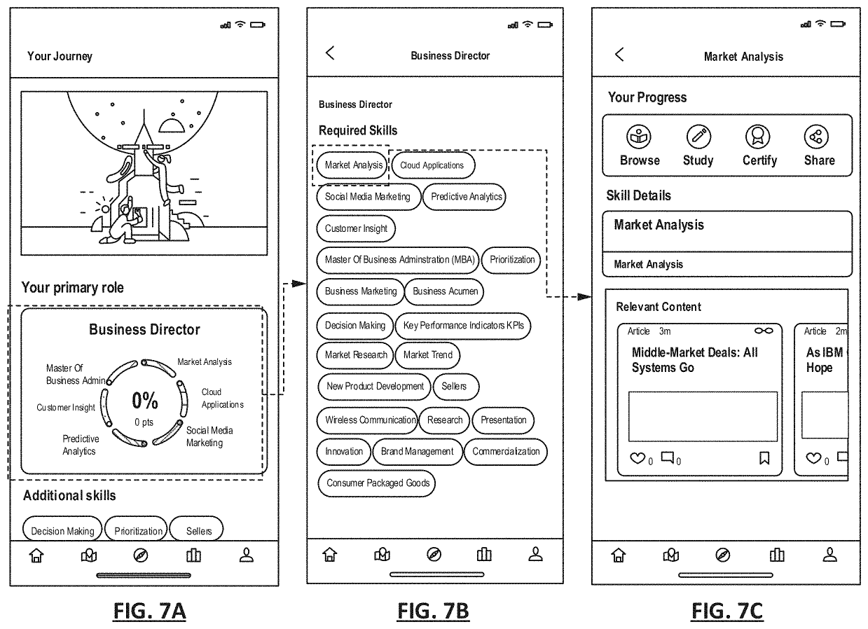

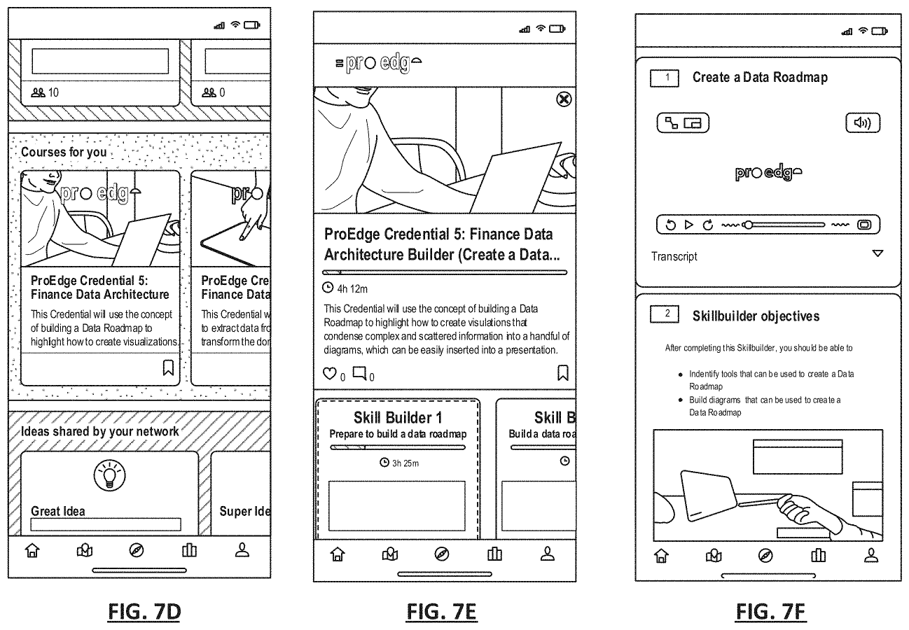

At block 608, in some embodiments, the system may receive, from a user device associated with the user, a first media content object request. In some embodiments, the media content object request may be executed by a user (e.g., upskilling learner 124 of system 100) of a computer or mobile electronic device, via a graphical user interface configured to allow the user to browse and consume upskilling content. The request may be received as one or more inputs executed via a GUI such as the GUI described below with reference to FIGS. 7A-7F. In some embodiments, the user corresponding to the user profile generated at block 604 may execute a request for one or more media content objects, for example by using a GUI to navigate to a screen for displaying available, suggested, and/or required upskilling content for consumption by the user.

In some embodiments, the request may specify one or more criteria (e.g., filtering criteria) for selecting a media content object. For example, the user may specify a certain topic area, a certain media content object type, and/or a certain skill gap to be addressed by the selected media content object.

Data regarding the user's media content object request may be transmitted from the user's device to one or more processors of the system (e.g., engine 102) for processing of the request.

At block 610, in some embodiments, the system may, in response to receiving the first media content object request, select one or more of the plurality of media content objects wherein the selected one or more media content objects are indicated by the metadata as being associated with a skill that is associated with a skill level indicated in the user profile. In some embodiments, the selection may be made before receiving the user request, while in some embodiments the selection may be made in response to receiving the user request.

The selection may be performed by the system (e.g., in an automated and/or algorithmic manner) based at least in part on the user profile and the media content data received by the system. For example, skill data associated with the received media content may be used by the system to select media content on the basis of a determination by the system that skill data for the media content indicates that consumption/completion of the media content will add a skill or increase a skill level for which a user profile indicates a skill gap.

Additionally or alternatively, the selection may be performed by the system (e.g., in an automated and/or algorithmic manner) based at least in part on the received user input, for example in a case where the received user input selects a specific piece of upskilling content or where the user input indicates one or more criteria for filtering/selecting content.

At block 612, in some embodiments, the system may transmit, to the user device associated with the user, an indication of the selected one or more media content objects. In some embodiments, data for visualizing or otherwise presenting an indication of what media content objects were selected may be transmitted to the user device, such that, e.g., titles and/or title cards can be visualized on a GUI displayed on the user's device. In some embodiments, media content objects (e.g., videos, articles, interactive trainings, etc.) themselves may be transmitted to the user device, such that the media content object can be displayed or otherwise presented on the user device and consumed by the user.

At block 614, in some embodiments, the system may receive an indication from the user device that the user has consumed the media content object. The indication may be transmitted from the user device (e.g., a device of learner 124) to one or more processors (e.g., engine 102) of the system, and the indication may include information indicating one or more of the following: which content was consumed, when the content was consumed, an extent of completion of consumption of the content, and information regarding performance of the user in completing/consuming the content. Performance information may indicate, for example, a user's score on a quiz or other interactive portion of a training.

At block 616, in some embodiments, the system may, in accordance with the indication received from the user device, update the user profile for the user to indicate an increase in the skill level, wherein the skill level that is increased is indicated by the metadata as being associated with the media content object. A skill level increase afforded to a user in response to the user completing/consuming upskilling content may in some embodiments be a fixed skill level increase (e.g., a predetermined number of skill points for a predetermined skill) indicated in skill information associated with the content. In some embodiments, a skill level increase may be afforded in accordance with an extent of completion of the content, such that partial completion will afford a smaller skill level increase. In some embodiments, a skill level increase may be afforded in accordance with a user's performance on an interactive training, such that higher scores will afford a higher skill level increase. In some embodiments, a skill level increase may be determined in accordance with a timeliness with which a user completes/consumes content. In some embodiments, a skill level increase may be determined based on the user's preexisting skill levels, such that a user's skill levels may be increased by a percentage of their preexisting skill levels, or may be increased by any amount that is calculated as a function of the user's preexisting skill levels (and, optionally, one or more additional variables).

The system may update the user profile to reflect a change in user skills (e.g., acquiring a new skill and/or increasing a skill level) by saving new data to a data structure representing the user profile, or by updating a data structure representing a user profile. The updated or new data may be saved, for example, on a database of user library 153.

At block 618, in some embodiments, the system may, in accordance with the indication received from the user device, provide an updated selection of media content objects for future consumption by the user. In some embodiments, the system may automatically (e.g., algorithmically) select one or more new or additional media content objects to be presented to the user as recommended or required. This selection may be based on the user's increased skill levels. For example, as a user adds new skills and/or increases skill levels to close prior skill gaps, the system may cease to recommend content for skill gaps that no longer need to be closed. Additionally or alternatively, the system may recommend new content for which the user is newly qualified, either because the users new skills newly meet prerequisite requirements for said new content, or because the user's completion of the prior content has allowed the user to progress through a predefined track of content to “unlock” the newly available content. Newly selected media content objects may be indicated in a GUI for the user to browse, and/or may be transmitted to the user for consumption.

FIGS. 7A-7E show graphical user interface screens for browsing and consuming upskilling content, according to some embodiments. The GUI screens shown in FIGS. 7A-7E may, in some embodiments, be displayed on a device of a user such as learner 124 of system 100, and/or such as a user for whom media content is selected and provided in method 600.

FIG. 7A shows an upskilling journey overview screen, according to some embodiments. In some embodiments, a user undergoing an upskilling journey may consume upskilling content (e.g., media content objects) in order to earn one or more skills and/or to increase one or more skill levels. As described herein, the one or more skills that the user may earn may help to close a skill gap for the user that may be calculated based on a difference between the user's current skills and skill levels as compared to target skills and skill levels for a role associated with the user.

As shown, the upskilling journey overview screen may comprise a role summary visualization. A role summary visualization may be configured to display skill data related one or more skills associated with a role; the skill data displayed may visualize a comparison of a current skill level for the user versus a target skill level (e.g., as determined by a role of the user) for the user. In some embodiments, the role summary visualization may be a pie chart or a circle chart. The amount of time that the user may spend earning each skill and/or the relative importance of each skill for the role may be indicated visually on the role summary visualization. In some embodiments, the role summary visualization may indicate the user's upskilling journey progress with a completion percentage and/or a number of user-earned points.

FIG. 7B shows a required skills screen, according to some embodiments. In some embodiments, a required skills screen may be caused to be displayed by the system in response to a user of an upskilling journey overview screen tapping or clicking on a displayed skills visualization. As shown in FIG. 7B, the required skills screen may indicate a role for the user and may comprise a plurality of icons or other visual representations, wherein each of the plurality of icons may indicate and represent a skill required (or recommended) for the indicated role.

In some embodiments, the user of the screen shown in 7B may be able to use the GUI to modify or augment their target skills and/or skill levels (or may use one or more GUI screens of the system to do so), such that the user may be affording input into and/or control over which courses are selected for the user.

In some embodiments, one or more of the skill icons shown in FIG. 7B may be selectable by a user to cause the system to display upskilling content associated with that skill. As shown in the example of FIG. 7B, a user may select the icon for “market analysis” to cause a skill detail screen (FIG. 7C) for the “market analysis” skill to be displayed.

FIG. 7C shows a skill details screen, according to some embodiments. As shown, the skill details screen may indicate a skill for which detailed information and/or associated upskilling content are visualized. The skill details screen may be configured to display a visual indication of one or more pieces of upskilling content (e.g., media content objects) associated with the indicated skill. In some embodiments, the skill details screen may comprise an upskilling journey progress panel that may include one or more visual indicators showing a user's progress through interacting with upskilling content, such as by showing a user's progress through the steps of browsing content, studying content, earn a certificate for completion/consumption of content, and/or sharing their progress through the content.

FIG. 7D shows a course recommendation screen, according to some embodiments. A system for upskilling and digital asset management may be configured to recommend one or more courses to a user based on a role and/or skills associated with the user, for example based on one or more skill gaps for the user. The course recommendation screen may be configured to display a visual representation of one or more course recommendations for the user. As shown, the course recommendation visualizations may comprise a course title, a credential number, a course description, and/or a course category. In some embodiments, the user may select a course of interest of the one or more recommended courses, for example by clicking or tapping the visualization, in order to cause additional information about the selected course to be displayed. In some embodiments, the course recommendation screen may include interactive bookmarking icons associated with a visualization of a course, such that the user can bookmark the represented course for review at a later time.

FIG. 7E shows a course details screen, according to some embodiments. As shown, the course details screen may display information regarding a course that may have been selected by the user on a course recommendation screen, for example the course recommendation screen shown in FIG. 7D. In some embodiments, the course details screen may display information related to the selected course. In some embodiments, the course details screen may comprise icons which allow the user to “like”, comment on, and/or bookmark the selected course. In some embodiments, the course details screen may display a visual representation of one or more media content objects that are included within the course. For example, a single course may include a plurality of “skill builder” media content objects, which may for example be videos or interactive trainings. A visualization of a media content object included in the course may show information regarding time needed to complete the media content object and/or information regarding the user's progress through the media content object (e.g., by way of a progress bar). A visualization of a media content object included in the course may be selectable by the user to cause the media content object to be displayed on the user's device for consumption by the user.

FIG. 7F shows a media content object display screen, according to some embodiments. In the example shown, a skill builder video screen is displayed. As shown, the GUI screen includes a video display region for display of a video included in the skill builder upskilling content. As shown, the GUI screen additionally includes a visualization of a set of objectives for the skill builder upskilling content. In some embodiments, by watching the video and viewing the objectives information on the GUI screen shown in FIG. 7F, the user may consume/complete the media content object and may earn (or progress towards earning) new skills or skill-level increases associated with the media content object.

While FIG. 7F shows an interface for consuming video content as part of an upskilling journey, upskilling content may in some embodiments include one or more interactive exercise including practical exercised that require a user to build a digital asset, write program code, draft a document, create or edit electronic media, or the like. In some embodiments, these kinds of projects may be undertaken as part of a “Capstone” project that is unlocked and accessible to users after the user has completed prerequisite skill builder courses. In some embodiments, in order to complete one or more interactive exercise, a user may be prompted by the system to download an executable program to their own device, wherein the downloaded program is usable to complete the interactive exercise. Alternatively or additionally, the system may prompt the user to access a virtual desktop interface in order to complete the interactive exercise without the need to download a program onto the user's own computer or device.

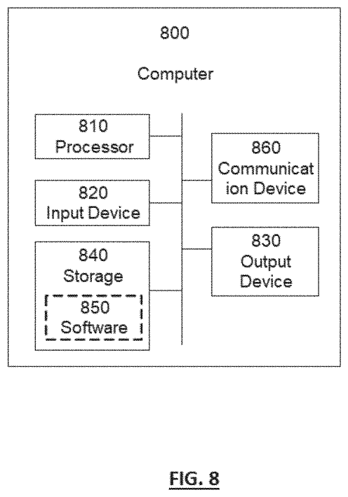

FIG. 8 shows a computer, in accordance with some embodiments. Computer 800 can be a component of an upskilling and digital asset management system according to the systems and methods described above, such as system 100 of FIG. 1. In some embodiments, computer 800 may execute a one or more of the methods described herein, such as a method for providing upskilling content.

Computer 800 can be a host computer connected to a network. Computer 800 can be a client computer or a server. As shown in FIG. 8, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein.

Software 850, which can be stored in storage 840 and executed by processor 810, can include, for example, the programming that embodies the functionality of the present disclosure (e.g., as embodied in the systems, computers, servers, and/or devices as described above). In some embodiments, software 850 can include a combination of servers such as application servers and database servers.

Software 850 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A system for associating media content with roles, the system comprising one or more processors configured to cause the system to:
receive a first data set comprising a plurality of role descriptions, wherein one or more of the plurality of role descriptions comprises an indication of one or more skills;
receive a second data set comprising an indication of a plurality of media content objects;
generate, based on the first data set, the role profile for the role, wherein the role profile comprises data indicating a plurality of skills associated with the role; and
generate, based on the second data set, data associating the role profile with one or more media content objects of the plurality of media content objects.

2. The system of claim 1, wherein receiving the first data set comprises receiving data from one or more sources selected from: a job posting data source; a job description data source, a data source associated with a single entity of the plurality of entities; a data source associated with more than one of the plurality of entities; and a social media data source.

3. The system of claim 1, wherein receiving the first data set comprises one or more methods of receipt selected from: performing automated scraping of one or more data sources, receiving a batch upload; receiving the first data set according to a predetermined schedule; receiving the first data set in response to a predefined trigger condition; and receiving an update to previously-received data.

4. The system of claim 1, wherein receiving the second data set comprises receiving data from one or more sources selected from: a courses data source configured to provide a plurality of course media content objects; a credentials data source configured to provide a plurality of credential media content objects, and a news/articles content data source configured to provide a plurality of news/article media content objects

5. The system of claim 1, wherein receiving the second data set comprises one or more methods of receipt selected from: performing automated scraping of one or more data sources, receiving a batch upload; receiving the second data set according to a predetermined schedule; receiving the second data set in response to a predefined trigger condition; and receiving an update to previously-received data.

6. The system of claim 1, wherein generating the role profile comprises applying one or more automated algorithms.

7. The system of claim 1, wherein generating the data associating the role profile with the one or more media content objects comprises applying one or more automated algorithms.

8. The system of claim 1, wherein generating the data associating the role profile with the one or more media content objects is based on the plurality of skills associated with the role.

9. The system of claim 8, wherein the system is configured to select, from the second data set, a subset of media content objects to be associated with the role profile, wherein the selection is based on the role profile and the second data set indicating that the role and the subset of media content objects are commonly associated with one or more skills.

10. The system of claim 1, wherein the one or more processors are further configured to cause the system to:
receive a user input comprising an instruction to modify the data associating the role profile with the one or more media content objects; and
in response to receiving the user input, modify the data associating the role profile with the one or more media content objects in accordance with the user input.

11. The system of claim 1, wherein the instruction to modify the data associating the role profile with the one or more media content objects comprises an instruction to perform one or more of the following: associating a new media content object with the role profile, disassociating one or more of the media content objects from the role profile, modifying an indicated importance of one or more of the media content objects to the role, and modifying a display order for one or more of the media content objects for the rile profile.

12. The system of claim 1, wherein the data associating the role profile with one or more media content objects comprises an indication of one or more worker skill levels to be modified in response to detecting that a respective media content object has been consumed by the worker.

13. The system of claim 12, wherein the one or more processors are further configured to cause the system to determine the one or more worker skill levels based on the second data set indicating that the respective media content object is associated with one or more skills associated with the one or more worker skill levels.

14. A method for associating media content with roles, the method performed at a system comprising one or more processors, the method comprising:
receiving a first data set comprising a plurality of role descriptions, wherein one or more of the plurality of role descriptions comprises an indication of one or more skills;
receiving a second data set comprising an indication of a plurality of media content objects;
generating, based on the first data set, the role profile for the role, wherein the role profile comprises data indicating a plurality of skills associated with the role; and
generating, based on the second data set, data associating the role profile with one or more media content objects of the plurality of media content objects.

15. A non-transitory computer-readable storage medium storing instructions for associating media content with roles, wherein the instructions are executable by a system comprising one or more processors to cause the system to:
receive a first data set comprising a plurality of role descriptions, wherein one or more of the plurality of role descriptions comprises an indication of one or more skills;
receive a second data set comprising an indication of a plurality of media content objects;
generate, based on the first data set, the role profile for the role, wherein the role profile comprises data indicating a plurality of skills associated with the role; and
generate, based on the second data set, data associating the role profile with one or more media content objects of the plurality of media content objects.

16. A system for visualizing workforce data, the system comprising one or more processors configured to cause the system to:
receive a first data set comprising an indication of an organizational structure and respective descriptions of a plurality of entities within the organizational structure;
cause display of a graphical user interface comprising a visualization region;
receive, via the graphical user interface, a first user input comprising an indication of a member within the organizational structure; and
in response to receiving the first input, cause display in the display region of a visualization of information regarding the member.

17. The system of claim 16, wherein the indication of an organizational structure comprises an organizational chart.

18. The system of claim 16, wherein the first user input comprising an indication of a member comprises one or more inputs selected from the following: typing of the name of the member, selection of a user-interface affordance associated with the member, selection of the member from a list of the plurality of members within the organizational structure, selection of a visualization of the member within a visualization of the organizational chart.

19. The system of claim 16, wherein the visualization of information regarding the member comprises a visualization of one or more of the following: a member role for the member, a member skill level for a skill of the member, and a member engagement level characterizing engagement by the member with one or more media content object.

20. The system of claim 16, wherein:
the one or more processors are further configured to cause the system to:
receive a second data set comprising an indication of a plurality of media content objects; and
associate the member with a set of one or more of the plurality of media content objects; and
the visualization indicates an association of the member with all or part of the set of media content objects.

21. The system of claim 20, wherein receiving the second data set comprises receiving data from one or more sources selected from: a courses data source configured to provide a plurality of course media content objects; a credentials data source configured to provide a plurality of credential media content objects, and a news/articles content data source configured to provide a plurality of news/article media content objects.

22. The system of claim 20, wherein receiving the second data set comprises one or more methods of receipt selected from: performing automated scraping of one or more data sources, receiving a batch upload; receiving the second data set according to a predetermined schedule; receiving the second data set in response to a predefined trigger condition; and receiving an update to previously-received data.

23. The system of claim 20, wherein associating the member with the set of media content objects comprises applying one or more automated algorithms.

24. The system of claim 20, wherein associating the member with the set of media content objects is based on a determination by the system, based on the information regarding the member and based on the second data set, that the member and the one or more of the plurality of media content objects are commonly associated with a same role.

25. The system of claim 20, wherein associating the member with the set media content objects is based on a determination by the system, based on the information regarding the member and based on the second data set, that the member and the one or more of the plurality of media content objects are commonly associated with a same skill.

26. The system of claim 20, wherein one or more processors are further configured to automatically select subset of the set of media content objects for inclusion in the visualization, wherein selection of the subset is based on comparing a current skill level of the member to a target skill level for members of a same role type as the member.

27. The system of claim 20, wherein the visualization indicating an association of the member with all or part of the set of media content objects further indicates a progress level of the member in engaging one or more of the set of media content objects.

28. A method for visualizing workforce data, the method performed at a system comprising one or more processors, the method comprising:
receiving a first data set comprising an indication of an organizational structure and respective descriptions of a plurality of members within the organizational structure;
causing display a graphical user interface comprising a visualization region;
receive, via the graphical user interface, a first user input comprising an indication of a member within the organizational structure; and
in response to receiving the first input, causing display in the display region of a visualization of information regarding the member.

29. A non-transitory computer-readable storage medium storing instructions for visualizing workforce data, wherein the instructions are executable by a system comprising one or more processors to cause the system to:
receive a first data set comprising an indication of an organizational structure and respective descriptions of a plurality of members within the organizational structure;
display a graphical user interface comprising a visualization region;
receive, via the graphical user interface, a first user input comprising an indication of a member within the organizational structure; and
in response to receiving the first input, cause display in the display region of a visualization of information regarding the member.

30. A system for providing media content, the system comprising one or more processors configured to cause the system to:
receive user data comprising an indication of a first plurality of skills for a user;
generate and store a user profile for the user based on the user data, wherein the user profile indicates a plurality of skill levels for the user;
receive media content data comprising a plurality of media content objects and metadata indicating associations of the respective media content objects with a second plurality of skills;
receive, from a user device associated with the user, a first media content object request; and
in response to receiving the first media content object request:
select one or more of the plurality of media content objects, wherein the selected one or more media content objects are indicated by the metadata as being associated with a skill associated with a skill level indicated in the user profile; and
transmit, to a user device associated with the user, an indication of the selected one or more media content objects.

31. The system of claim 30, wherein the user profile indicates a skill level for a first skill of the first plurality of skills.

32. The system of claim 30, wherein receiving the media content data comprises receiving data from one or more sources selected from: a courses data source configured to provide a plurality of course media content objects; a credentials data source configured to provide a plurality of credential media content objects, and a news/articles content data source configured to provide a plurality of news/article media content objects.

33. The system of claim 30, wherein:
the user device associated with the user comprises one or more selected from: a personal computer, a mobile device, and a workstation computer;
the system is configured to cause the user device to display a graphical user interface configured to display media content to the user; and
the first media content object request comprises the user navigating to a media content portion of the graphical user interface.

34. The system of claim 30, wherein selecting the one or more media content objects is based on a comparison of the skill level indicated in the user profile against a target skill level for members of a role type indicated by the user profile.

35. The system of claim 30, wherein the one or more processors are further configured to:
receive an indication from the user device that the user has consumed the media content object; and
in accordance with the indication received from the user device, update the user profile for the user to indicate an increase in the skill level, wherein the skill level that is increased is indicated by the metadata as being associated with the media content object.

36. The system of claim 35, wherein the system determines an amount by which to increase the skill level in accordance with a performance level by the user in consuming the media content object.

37. The system of claim 35, wherein the system is further configured to, in accordance with the indication received from the user device, provide an updated selection of media content objects for future consumption by the user.

38. The system of claim 30, wherein the selected one or more media content objects comprise one or more selected from the group of: a video, a slide show, an article, and an interactive assessment.

39. A method for providing media content, the method performed at a system comprising one or more processors, the method comprising:
receiving user data comprising an indication of a first plurality of skills for a user;
generating and store a user profile for the user based on the user data, wherein the user profile indicates a plurality of skill levels for the user;
receiving media content data comprising a plurality of media content objects and metadata indicating associations of the respective media content objects with a second plurality of skills;
receiving, from a user device associated with the user, a first media content object request; and
in response to receiving the first media content object request:
selecting one or more of the plurality of media content objects, wherein the selected one or more media content objects are indicated by the metadata as being associated with a skill associated with a skill level indicated in the user profile; and
transmitting, to a user device associated with the user, an indication of the selected one or more media content objects.

40. A non-transitory computer-readable storage medium storing instructions for providing media content, wherein the instructions are executable by a system comprising one or more processors to cause the system to:
receive user data comprising an indication of a first plurality of skills for a user;
generate and store a user profile for the user based on the user data, wherein the user profile indicates a plurality of skill levels for the user;
receive media content data comprising a plurality of media content objects and metadata indicating associations of the respective media content objects with a second plurality of skills;
receive, from a user device associated with the user, a first media content object request; and
in response to receiving the first media content object request:
select one or more of the plurality of media content objects, wherein the selected one or more media content objects are indicated by the metadata as being associated with a skill associated with a skill level indicated in the user profile; and
transmit, to a user device associated with the user, an indication of the selected one or more media content objects.
